(19) United States
(12) Patent Application Publication
(10) Pub. No.: US 2008/0088608 A1
(43) Pub. Date: Apr. 17, 2008

(54) Control Apparatus With a Rotating Wheel and Pushbutton

(75) Inventor: Johann Schwarzhuber, Wolnzach (DE)

Correspondence Address: EDELL, SHAPIRO & FINNAN, LLC, 1901 RESEARCH BOULEVARD, SUITE 400, ROCKVILLE, MD, 20850, US

(73) Assignee: WILLTEK COMMUNICATIONS GMBH, Ismaning (DE)

(21) Appl. No.: 11/873,785

(22) Filed: Oct. 17, 2007

Related U.S. Application Data
(63) Continuation of application No. PCT/EP2006/003423, filed on Apr. 13, 2006.

(30) Foreign Application Priority Data
Apr. 17, 2005 (DE) 102005017781.6

(51) Int. Cl. G06F 3/033

(52) U.S. Cl. 345/184

(57) ABSTRACT

A space-saving and user-friendly operating device includes a rotary transducer to which a rotating wheel is connected. The operating device also includes at least one tracer arranged behind the rotating wheel section, wherein a pressure produced by the rotating wheel section also produces a pressure on the tracer.

### CROSS REFERENCE TO RELATED APPLICATIONS

This application is a continuation of International Application No. PCT/EP2006/003423, filed on Apr. 13, 2006, entitled “Operating Device for a Rotating Wheel and a Tracer,” which claims priority under 35 U.S.C. §119 to Application No. DE 102005017781.6 filed on Apr. 17, 2005, entitled “Operating Device for a Rotating Wheel and a Tracer,” the entire contents of which are hereby incorporated by reference.

### FIELD OF THE INVENTION

The present invention relates to a control/operating apparatus with a rotary transmitter and a rotating wheel connected to the rotary transmitter.

### BACKGROUND

A number of control apparatuses, in particular having a rotary transmitter, are known from the prior art. Rotary transmitters such as these can be used, for example, to make inputs for an electronic appliance, simply, quickly, and precisely. Furthermore, a number of cursor input apparatuses are known. Cursor input apparatuses such as these are used for moving and/or controlling a cursor on a display, for example a monitor.

However, the known apparatuses have the disadvantage that their arrangement on the outside of a housing consumes a large amount of space. Several man to machine interfaces (e.g., input and output devices) must be accommodated in modern electronic appliances. In particular, there is a need for the output devices, in the form of indications or displays, to be as large as possible, which means that the individual interface must be designed and arranged to save as much space as possible.

### SUMMARY

The object of the present invention is therefore to develop a control device of the type mentioned initially such as its functionality in terms of input capabilities is improved.

The object according to the invention is achieved for a control apparatus of the type mentioned initially in that the control apparatus furthermore has at least one pushbutton which is arranged behind a section of the rotating wheel, and in which case the at least one pushbutton can be depressed by pressing the section of the rotating wheel.

In addition to the space-saving integration of the pushbuttons by means of which cursor control is provided, behind the rotating wheel the control process is also simplified, allowing faster control actions since there is no longer any need, as in the case of the prior art, to switch backwards and forwards between the rotating wheel and the cursor control, since these were physically separate. The user can make his rotating wheel and pushbutton inputs at essentially the same point.

The section is advantageously arranged near an outer edge of the rotating wheel. The configuration with the section being arranged near the outer edge, or eccentric or offset with respect to the shaft, allows the cursor input to be made independently of a conventional rotating wheel input. Furthermore, the appropriate space, in particular for a plurality of pushbuttons, is available physically near the outer edge of the rotating wheel.

According to one optional design variant of the invention, the rotating wheel can be tilted axially in order to depress the section of the rotating wheel. This allows the multifunctional nature of the rotating wheel to be achieved with a particularly good design on the basis of the present connection.

Furthermore, according to a further variant of the present invention, it is preferable for the rotating wheel to be elastic. This can be achieved, for example, by an appropriate material choice for the rotating wheel or the shaft.

In one preferred exemplary embodiment of the present invention, the rotating wheel is connected via a joint to a shaft of the rotary transmitter. A joint which is arranged between the rotating wheel and the shaft in this case ensures the capability to tilt the rotating wheel from the rotation axis or the shaft axis, so that the pushbuttons can be depressed “through the rotating wheel”.

Alternatively or additionally, the rotating wheel is advantageously connected to the rotary transmitter via a shaft which is mounted in the rotary transmitter with a joint. In this embodiment, the shaft can therefore itself be tilted away from the axis, thus allowing the mechanism to be accommodated in the housing interior.

The control device is preferably an input device, with the rotating wheel being provided in order to input numerical values, and with the pushbuttons being provided in order to control a cursor on a display device. Particularly for the field of mobile telephone testings, but also in different fields of technology, it is necessary to set numerical values for a multiplicity of parameters, for example parameters relating to a measurement. In this case, the rotating wheel allows numerical values for a parameter to be entered easily, and it is possible to change quickly and easily between the parameters by means of the pushbuttons, which are used for cursor control.

Furthermore, it is preferable for the control device to have four pushbuttons, which are each offset through about 90° with respect to one another adjacent to the horizontal and vertical edge areas of the rotating wheel. The arrangement of the pushbuttons in a corresponding manner to a compass face or a clock allows cursor control to be achieved in a manner which can be comprehended particularly easily and intuitively, in which case this also ensures, in particular, that the cursor inputs do not interfere with the other rotary inputs or with other cursor inputs.

The at least one pushbutton is advantageously fitted to or mounted on a panel/(circuit) board, with the pushbuttons being exposed through an opening in the housing wall when the control device is installed in a housing. According to this design refinement of the invention, the pushbutton signals can be passed on (electrically) particularly easily.

Further preferred embodiments of the invention are disclosed in the dependent patent claims.

The invention, as well as further features, aims, advantages and application examples of it, will be explained in more detail in the following text using a description and with reference to the attached drawings. In the drawings, the same reference symbols denote the same or corresponding elements. In this case, all of the features which are described and/or which are illustrated in the form of figures form the subject matter of the present invention in their own right or any desired worthwhile combination, to be precise independently of the manner in which they are combined in the patent claims or their back-reference.

### BRIEF DESCRIPTION OF THE DRAWINGS

The invention is explained in more detail below with reference to accompanying drawings, where:

FIG. 1 shows a schematic cross-sectional view in order to explain a control apparatus according to one exemplary embodiment;

FIG. 2 shows a schematic plan view of the control apparatus according to the exemplary embodiment, as shown in FIG. 1; and

FIG. 3 shows a schematic illustration of a further exemplary embodiment, with a control apparatus which is integrated in a radio measurement station with a display, in order to explain the operation of the control apparatus.

### DETAILED DESCRIPTION

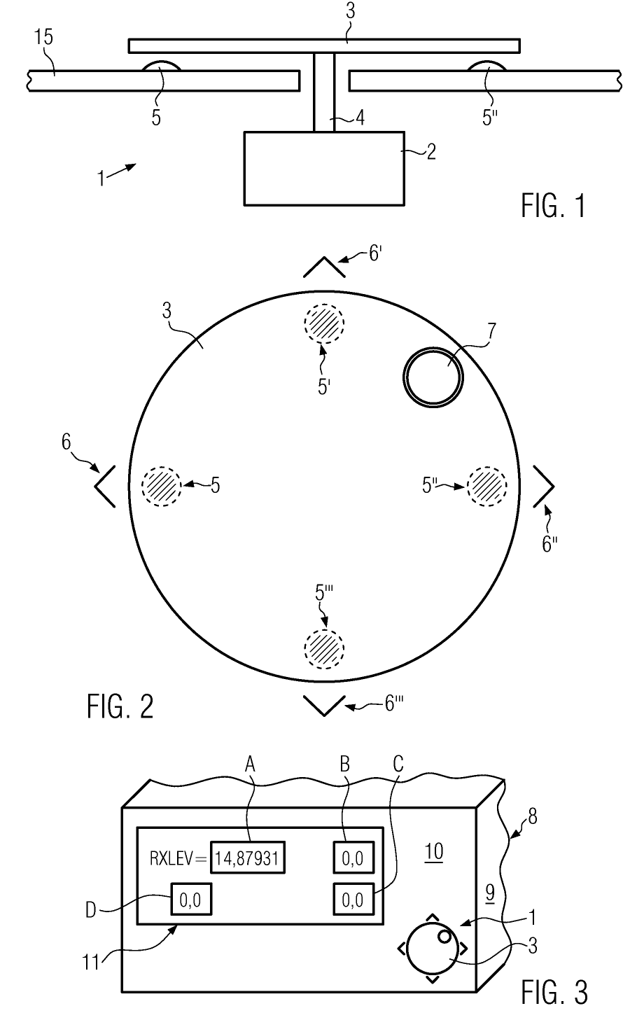

The schematic cross-sectional illustration in FIG. 1 shows that the control/operating apparatus 1 according to the embodiment comprises a rotary transmitter 2 which is connected to a rotating wheel 3 via a shaft 4. The rotary transmitter 2 as well as an (inner) part or section of the shaft 4 are arranged within a housing 8 (see FIG. 3). The rotating wheel 3 is arranged together with an (outer) part or section of the shaft 4 outside the housing 8, and is thus freely accessible to an operator. The shaft 4 thus passes through an opening in the front face 10 of the housing 8. In addition to the control apparatus 1 being configured and operable to input rotary information, specifically the control apparatus comprising: the rotary transmitter 1, the rotating wheel 3 and the shaft 4, the control apparatus 1 likewise comprises a cursor device which is integrated in the control apparatus 1. Two pushbuttons or key switches 5, 5″ of these are illustrated in the schematic illustration in FIG. 1. The pushbuttons 5, 5″ are arranged along a horizontal on the outside of the housing wall 10 opposite with respect to an edge area or section of the rotating wheel 3. A user can operate the pushbuttons 5 or 5″ by depressing the appropriate points, which are opposite the pushbuttons 5, 5″, in the edge area of the rotating wheel 3. As can be seen from the illustration in FIG. 2, a total of four pushbuttons or key switches 5, 5′, 5″ and 5″′ are optionally arranged under or behind the rotating wheel 3 on the housing wall 10 at positions which correspond approximately to “nine o'clock”, “twelve o'clock”, “three o'clock” and “six o'clock”. The key switches or pushbuttons 5, 5″ are arranged essentially along a horizontal, and the key switches or pushbuttons 5′ and 5″′ are arranged essentially along a vertical. The four pushbuttons 5, 5′, 5″ and 5″′ provide an input capability for cursor control. The pushbuttons 5, 5′, 5″ and 5″′ are arranged on a (keypad) panel/(circuit) board, in order to allow the information associated with pushbutton operation to be passed on. The cursor control which is provided according to the embodiment allows four directions to be input, optionally “up” and “down” as well as “left” and “right”. To be more precise, the pushbutton 5, as indicated by the marking 6 provided alongside the pushbutton 5 on the outside of the housing wall 10 is used to move a cursor to the left. In a corresponding manner, a marking 6′ is provided for the pushbutton 5′ (“upwards”), a marking 6″ is provided for the pushbutton 5″ (“to the right”), and a marking 6″′ is provided for the pushbutton 5″′ (“downwards”). A cursor keypad is therefore integrated in the rotary transmitter. As can also be seen from FIG. 2, a finger depression 7 is formed on the outside in the rotating wheel 3, in order to make it easier to rotate the rotating wheel 3.

One optional application of the present invention will now be explained in more detail in conjunction with the schematic illustration, which is partially cut away, in FIG. 3. The housing 8 is optionally a housing for a so-called radio measurement station or mobile phone tester (i.e., an appliance for testing mobile telephones). Appliances such as these are used, for example, during final inspection during the production of mobile telephones, in order to test the mobile telephones for compliance with the specifications required for operation, before delivery. A further application for radio test stations such as these for mobile telephones is for repair and fault diagnosis. While mobile telephones are being tested, the radio measurement station simulates a base station by setting up a test radio network in which the mobile telephone, which is fitted with a test SIM card, registers. A series of parameters must be set in order to test mobile telephones. For this purpose, on its front face 10, the housing 8 comprises a display device 11 in which, without any restriction to generality, four fields A, B, C and D are illustrated for parameters such as these. By way of example, the parameter RXLEV is indicated in the field A. According to the exemplary embodiment, the housing 8 likewise comprises the control apparatus 3 on its front face 10. The numerical value of the parameter RXLEV, which is displayed in field A, can now be set quickly and accurately by rotating the rotating wheel. If it is now necessary to set further parameters for the test process, then the active area or the cursor must be moved to the other input fields B, C or D, so that these parameters can also be set by rotation of the rotating wheel 3. In addition, by way of example, in order to move to the field B, the user can move the active area to the right, by depressing the rotating wheel at the point above the pushbutton 5″ (i.e., to the left alongside the marking 6″). The angular position of the rotating wheel 3 is not influenced by this, since the parameter RXLEV set in the field A is not intended to be changed in this case. In a corresponding manner, the user can move from the field B to the field D by operating the pushbutton 5″′, indicated by the marking 6″′, by depressing the six o'clock position on the rotating wheel 3. It should be noted that there are many ways in which the cursor keys can be integrated according to the invention in the rotary input apparatus, comprising the rotary transmitter 2, the rotating wheel 3 and the shaft 4. By way of example, the rotating wheel 3 may be designed to be elastic for this purpose. Furthermore, it is also possible for the rotating wheel to be connected to the shaft 4 of the rotary transmitter 2 via a joint (which is not illustrated). In principle, the invention can cover any embodiment via which the pushbuttons can be depressed or operated via the rotating wheel or through it. In particular, such embodiments also include any means which can be used to tilt the shaft axially or to pivot it about the axis so that the eccentrically arranged pushbuttons can be operated. By appropriate configuration of the pushbuttons 5, 5′, 5″ and 5″′ and their arrangement behind the rotating wheel 3, it is possible that only a small axial tilt is necessary in order to produce the cursor input according to the embodiment.

The invention has been explained above with reference to preferred embodiments of it. However, it is obvious to a person skilled in the art that different modifications and changes can be made without departing from the idea on which the invention is based.

What is claimed is:

1. A control apparatus, comprising:
a rotary transmitter;
a rotating wheel connected to the rotary transmitter; and
at least one pushbutton arranged behind a section of the rotating wheel, wherein the at least one pushbutton is operable to be depressed by pressing the section of the rotating wheel.

2. The control apparatus of claim 1, wherein the section of the rotating wheel is arranged adjacent to an outer edge of the rotating wheel.

3. The control apparatus of claim 1, wherein the rotating wheel is configured to tilt axially in order to depress the section of the rotating wheel.

4. The control apparatus of claim 1, wherein the rotating wheel is elastic.

5. The control apparatus of claim 1, wherein the rotary transmitter comprises a shaft, the control apparatus further comprising:
a joint connected to the shaft, thereby connecting the rotating wheel to the rotary transmitter.

6. The control apparatus of claim 1, further comprising:
a shaft mounted in the rotary transmitter; and
a joint connecting the rotating wheel to the mounted shaft.

7. The control apparatus of claim 1, wherein:
the control apparatus is an input device;
the rotating wheel is configured to input numerical values; and
the at least one pushbutton is configured to control a cursor of a display device.

8. The control apparatus of claim 1, wherein the at least one pushbutton comprises:
four pushbuttons arranged offset through about 90° with respect to one another and arranged adjacent to the horizontal and vertical edge areas of the rotating wheel.

9. The control apparatus of claim 1, further comprising:
a panel with the at least one pushbutton fitted thereon;
wherein the control apparatus is installed in a housing, the at least one pushbutton being exposed through an opening in a wall of the housing.

10. An electrical appliance, comprising:
a control apparatus comprising:
a rotary transmitter;
a rotating wheel connected to the rotary transmitter; and
at least one pushbutton arranged behind a section of the rotating wheel, wherein the at least one pushbutton is operable to be depressed by pressing the section of the rotating wheel.

11. The electrical appliance of claim 10, wherein the electrical appliance is a radio measurement station operable to test mobile communication devices.

12. The electrical appliance of claim 10, further comprising:
a display device configured to display numerical values;
wherein the control apparatus is an input device and the rotating wheel is configured and operable to input the numerical values of the display device.

13. The electrical appliance of claim 10, further comprising:
a display device configured to display a cursor;
wherein the control apparatus is an input device and the at least one pushbutton is configured and operable to control the cursor of the display device.

14. The electrical appliance of claim 10, further comprising:
a display device configured to display numerical values and a cursor; wherein:
the control apparatus is an input device and the rotating wheel is configured and operable to input the numerical values of the display device; and
the at least one pushbutton is configured and operable to control the cursor of the display device.
